(19) United States
(12) Patent Application Publication
(10) Pub. No.: US 2013/0007316 A1
(43) Pub. Date: Jan. 3, 2013

(54) PLUG AND PLAY SENSOR MODULE, SENSOR NODE, AND PLUG AND PLAY CONNECTION METHOD

(75) Inventors: Young-Bag MOON, Daejeon-si (KR); Nae-Soo KlM, Daejeon-si (KR); Seong-Bae EUN, Daejeon-si (KR)

(73) Assignees: Hannam University Institute for Industry-Academia Cooperation, Daejeon-si (KR); ELECTRONICS AND TELECOMMUNICATIONS RESEARCH INSTITUTE, Daejeon-si (KR)

(21) Appl. No.: 13/470,246

(22) Filed: May 11, 2012

(30) Foreign Application Priority Data
Jun. 30, 2011 (KR) 10-2011-0065060

(51) Int. Cl. G06F 13/38

(52) U.S. Cl. 710/62

(57) ABSTRACT

A plug and play sensor module and sensor node are provided. The plug and play sensor module includes a sensor, a sensor interface that transmits and receives a signal for plug and play connection to and from a sensor node, and a plug and play connection processing unit that transmits a signal for connection confirmation to the sensor node through the sensor interface when being connected to the sensor node, and transmits sensor identification (ID) information to the sensor node when a sensor ID is requested by the sensor node.

### CROSS-REFERENCE TO RELATED APPLICATION

This application claims the benefit under 35 U.S.C. §119(a) of Korean Patent Application No. 10-2011-0065060, filed on Jun. 30, 2011, the disclosure of which is incorporated by reference in its entirety for all purposes.

### BACKGROUND

1. Field

The following description relates to a sensor technique, and more particularly, to a technique in which a sensor node and a sensor are connected in a plug and play form.

2. Description of the Related Art

A sensor used in a sensor node has the same physical environment information to be measured; however, there are many methods for sensors according to the type, such as a voltage and a consumption current for using the sensor, a time up to operation, data output, and the like. Selection from such various sensors may differ depending on performances required for application services and operating environments. In the related art, sensors which are suitable for the performances required for the application service are mostly configured in an integrated hardware type which is built in the sensor node. However, in recent years, various application services have been provided, and sensors that apply to each application service are diversified.

Accordingly, it has been difficult to manufacture sensors such that the sensor and the sensor node are integrally configured in order to apply various sensors for each application service.

### SUMMARY

The following description relates to a plug and play sensor module, a sensor node, and a plug and play connection method, which may overcome a problem that a sensor is required to be configured for each application service in a sensor node.

According to an exemplary aspect, there is provided a plug and play sensor module, including: a sensor; a sensor interface that transmits and receives a signal for plug and play connection to and from a sensor node; and a plug and play connection processing unit that transmits a signal for connection confirmation to the sensor node through the sensor interface when being connected to the sensor node, and transmits sensor identification (ID) information to the sensor node when a sensor ID is requested by the sensor node.

According to another exemplary aspect, there is provided a plug and play sensor node, including: a sensor interface that is used for connection with a sensor module; and a control unit that recognizes an input of the sensor module, and sets a plug and play connection.

According to still another exemplary aspect, there is provided a plug and play connection method in a sensor node, including: recognizing connection of a sensor module; requesting a sensor ID while allocating a communication address to the recognized sensor module; and setting an interface port with the sensor module and power in response to reception of the sensor ID.

According to still another exemplary aspect, there is provided a plug and play connection method in a sensor module, including: transmitting a signal for connection confirmation to a sensor node when being connected to the sensor node; and transmitting a sensor ID when the sensor ID is requested by the sensor node.

Other objects, features and advantages will be apparent from the following description, the drawings, and the claims.

### BRIEF DESCRIPTION OF THE DRAWINGS

FIG. 1 is a diagram showing a configuration in which a sensor node and a sensor module are connected in a plug and play method according to an exemplary embodiment of the present invention; and

FIG. 2 is a diagram showing a plug and play connection method of a sensor node and a sensor module according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

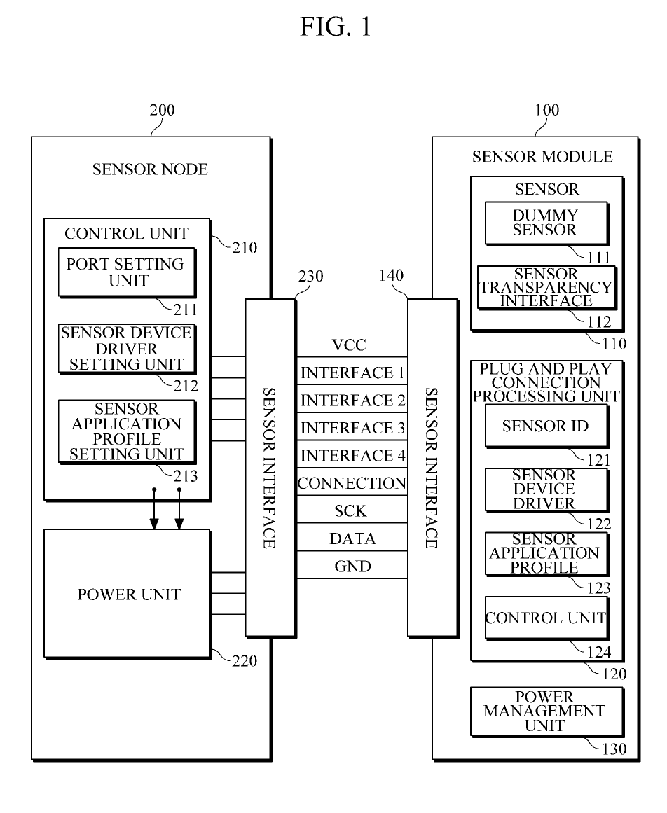

FIG. 1 is a diagram showing a configuration in which a sensor node and a sensor module are connected in a plug and play form according to an exemplary embodiment of the present invention.

According to the present invention, in order to overcome a configuration problem caused by a change of a sensor in a sensor node device in which the sensor is integrally provided, a sensor module in which a sensor to be used is made into a module as a separate device is manufactured, and only the sensor module is replaced while the sensor node is utilized as it is when a required sensor is changed in accordance with application services, thereby reducing development budget and time.

Referring to FIG. 1, a sensor module 100 and a sensor node 200 are connected in a plug and play form through sensor interfaces 140 and 230.

The sensor interfaces 140 and 230 are configured to receive all interface schemes in a universal manner. That is, a hardware interface is defined so as to prevent problems from occurring in power, sensing data transmission, and the like no matter what type of sensor is applied between the sensor module 100 and the sensor node 200.

The sensor module 100 includes a sensor 110, a plug and play connection processing unit 120, a power management unit 130, and a sensor interface 140. That is, the sensor 110 is made into a module, and the sensor interface 140 is configured in a hardware manner so that an interface part with the sensor node 200 can receive the sensor module having various interfaces in a universal manner, and also configured to match the sensor module 100 configured in a software manner by a method of automatically recognizing a sensor module.

The sensor 110, which denotes a physical sensor, is not shown in drawings, but may include a sensor 111 and a sensor transparency interface 112. The sensor uses a dummy sensor as it is, and performs different processings in accordance with sensor output characteristics on an interface board so as to overcome diversity of the sensors.

The plug and play connection processing unit 120 includes a sensor identification (ID) 121, a sensor device driver 122, a sensor application (App) profile 123, and a control unit 124.

The sensor ID 121 is information for identifying the sensor, and may include a sensor power type, a sensor interface type, and a sensor number. The sensor power type denotes a power specification required by a physical sensor, and the sensor interface type denotes an interface specification applied to communicate with the sensor node 200 and includes ADC, Interrupt, Frequency, I2C, and SPI. The sensor number is a serial number given by a sensor manufacturer.

The sensor ID 121 may be configured with, for example, a total of 36 bits. In this case, the following Table 1 may be obtained.

TABLE 1

| Power | Sensor Interface | Sensor |
|---|---|---|
| Type | Type | Number |
| 4 bits | 4 bits | 28 bits |

The sensor device driver 122 is a device driver of the sensor provided from the sensor node 200, is generated using functions of a hardware abstraction layer, and is divided into power initialization, On/Off, initialization/read/write for each interface scheme, and the like. Here, each of the functions uses a hardware mapping table index as a functional argument, and the hardware mapping table is information indicating a hardware connection state of the sensor interface.

The sensor application profile 123 is a profile that sets an initial value and the like of the sensor in advance for each application service to which the sensor is applied.

The control unit 124 serves to control communication between the sensor module 100 and the sensor node 200, and controls information of the sensor module 100 and transmission of the sensor device driver 122.

The power management unit 130 manages power of the sensor module 100, and maintains a voltage used in the sensor module 100 to be constant even when there are diversified voltages under which the sensor 100 is operated. An operation voltage of the sensor module 100 is, for example, 3 V as a reference. This is because the sensor node 200 is basically driven by a battery voltage of 3 V.

The sensor node 200 includes a control unit 210, a power unit 220, and a sensor interface 230.

The control unit 210 of the sensor node 200 includes software for a port setting unit 211, a sensor device driver setting unit 212, and a sensor App profile setting unit 213 for the purpose of a plug and play function.

The port setting unit 211 sets a connection port with respect to the sensor interface 230, which is a connection part with the sensor module 100, based on a sensor ID provided from the sensor module 100.

The sensor device driver setting unit 212 selects the sensor device driver by the sensor number, and sets the selected sensor device driver to be suitable for a sensor node environment. The sensor App profile setting unit 213 analyzes a sensor App profile provided from the sensor module 100, and sets a sensor value of the sensor module to be suitable for an application service to be applied.

The sensor module 100 and the sensor node 200 are connected by the sensor interfaces 140 and 230, and communication and setting for the plug and play are performed by an automatic recognition procedure between the sensor module 100 and the sensor node 200. Accordingly, by connecting only the sensor module 100 to the sensor node 200 by the plug and play function of the sensor module 100, developers and users may readily use the sensor module 100 and the sensor node 200.

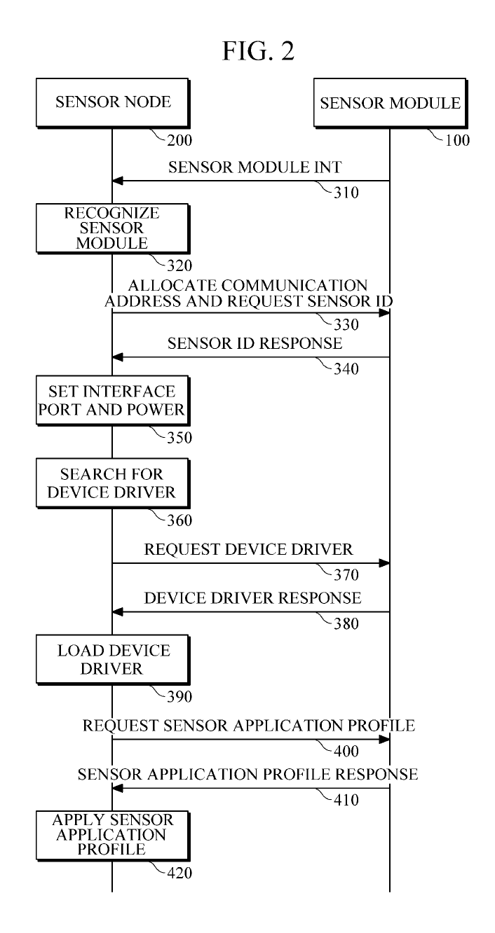

FIG. 2 is a signal flowchart showing a plug and play connection method of a sensor node and a sensor module according to an exemplary embodiment of the present invention.

Referring to FIG. 2, in step S310, when the sensor module 100 is connected to the sensor node 200, the sensor module 100 transmits an INT signal, which is a signal for connection confirmation, to the sensor node 200 using a connection pin of the sensor interface.

Thereafter, in step S320, the sensor node 200 recognizes that the sensor module 100 is connected by the INT signal. In step S330, a sensor ID is requested while a communication address is allocated to the sensor module 100. Next, in step S340, the sensor module 100 transmits its own sensor ID to the sensor node 200.

Next, in step S350, the sensor node 200 sets an interface port with the sensor module 100 and power when the sensor ID is delivered.

Next, in step S360, the sensor node 200 searches for a device driver of the sensor which is suitable for a sensor node platform according to the sensor number included in the sensor ID.

When no device driver is found based on the search result of step S360, the sensor node 200 requests the device driver in step S370 from the sensor module 100.

Next, in step S380, the sensor module 100 transmits the device driver to the sensor node 200 as the request response.

Next, in step S390, the sensor node 200 loads the searched or received device driver to thereby control the sensor.

In addition, in order to automatically set the sensor with respect to application services in which the sensor module 100 is applied and operated, the sensor node 200 requests a sensor App profile from the sensor module 100 in step S400, and is provided with the sensor App profile in step S410. Next, in step S420, the sensor node 200 automatically sets a sensor that is suitable for the application service using the provided sensor App profile.

As apparent from the above description, according to the embodiments of the present invention, the sensor node and the sensor module are connected in the plug and play form, and therefore, application service developers may develop application services regardless of types of the sensors.

In addition, according to the embodiments of the present invention, a procedure and a function for the plug and play function of the sensor node and the sensor module are provided, and therefore, the sensor module is automatically used without additional hardware or software development when various sensor modules are connected to the sensor node. As a result, a development period and a development burden may be reduced for sensor node developers.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A plug and play sensor module, comprising:
a sensor; and
a plug and play connection processing unit that transmits a signal for connection confirmation to a sensor node when being connected to a sensor node, and transmits sensor identification (ID) information to the sensor node when a sensor ID is requested by the sensor node.

2. The plug and play sensor module according to claim 1, wherein the plug and play connection processing unit includes the sensor ID that has information for identifying the sensor, and a control unit that controls communication with the sensor node, and transmits the sensor ID to the sensor node in response to the request of the sensor node.

3. The plug and play sensor module according to claim 2, wherein the sensor ID includes a sensor power type that is power specification information requested by the sensor, a sensor interface type that is an interface specification applied to communicate with the sensor node, and a sensor number that is a serial number given by a sensor manufacturer.

4. The plug and play sensor module according to claim 1, wherein the plug and play connection processing unit includes a device driver of the sensor which is provided to the sensor node.

5. The plug and play sensor module according to claim 1, wherein the plug and play connection processing unit includes a sensor application (App) profile that is information that enables information including an initial value of the sensor for each application service to which the sensor is applied to be set in advance.

6. The plug and play sensor module according to claim 1, further comprising:
a power management unit that maintains a voltage used in the sensor module to be constant.

7. A plug and play sensor node, comprising:
a sensor interface that is used for connection with a sensor module; and
a control unit that recognizes an input of the sensor module, and sets a plug and play connection.

8. The plug and play sensor node according to claim 7, wherein the control unit includes a port setting unit that sets a connection port with respect to the sensor interface that is a connection part with the sensor module based on a sensor ID provided from the sensor module, and a sensor device driver setting unit that selects and sets a sensor device driver according to a sensor number.

9. The plug and play sensor node according to claim 7, wherein the control unit includes a sensor App profile setting unit that analyzes a sensor App profile provided from the sensor module, and sets a sensor value of the sensor module corresponding to an application service to be applied.

10. A plug and play connection method in a sensor node, comprising:
recognizing connection of a sensor module;
requesting a sensor ID while allocating a communication address to the recognized sensor module; and
setting an interface port with the sensor module and power in response to reception of the sensor ID.

11. The plug and play connection method according to claim 10, further comprising:
searching for a device driver of a sensor corresponding to the sensor node by a sensor number included in the sensor ID; and
loading the searched device driver of the sensor to control the sensor.

12. The plug and play connection method according to claim 11, further comprising:
requesting the device driver from the sensor module when the device driver is not found; and
loading the received device driver to control the sensor when the device driver is received from the sensor module.

13. The plug and play connection method according to claim 10, further comprising:
requesting a sensor App profile from the sensor module;
receiving the sensor App profile; and
automatically setting the sensor suitable for an application service using the received sensor App profile.

14. A plug and play connection method in a sensor module, comprising:
transmitting a signal for connection confirmation to a sensor node when being connected to the sensor node; and
transmitting a sensor ID when the sensor ID is requested by the sensor node.

15. The plug and play connection method according to claim 14, further comprising:
searching for device driver information to transmit the searched device driver information to the sensor node when the device driver information is requested by the sensor node.

16. The plug and play connection method according to claim 14, further comprising:
searching for a sensor App profile to transmit the searched sensor App profile to the sensor node when the sensor App profile is requested by the sensor node.
